(19) United States
(12) Patent Application Publication
(10) Pub. No.: US 2025/0335692 A1
(43) Pub. Date: Oct. 30, 2025

(54) METHOD AND SYSTEM FOR AUTHORSHIP OBFUSCATION

(71) Applicant: RTX BBN Technologies, Inc., Cambridge, MA (US)

(72) Inventors: Sai Hemanth Kumar Kandula, Revere, MA (US); Damianos Karakos, Cherry Hill, NJ (US); Haoling Qiu, Arlington, MA (US); Michael Anthony Selvaggio, Somerville, MA (US); Brian Edward Ulicny, Winchester, MA (US)

(21) Appl. No.: 19/061,567

(22) Filed: Feb. 24, 2025

Related U.S. Application Data
(60) Provisional application No. 63/637,993, filed on Apr. 24, 2024.

(51) Int. Cl. G06F 40/103; G06F 40/166

(52) U.S. Cl. CPC G06F 40/103; G06F 40/166

(57) ABSTRACT

A method includes processing, by a system, input text, by applying a styling technique to at least a portion of the input text. Applying the styling technique generates intermediate output text of a style different from a style of the input text. The styling technique is selected based on one or more metrics associated with generating the intermediate output text. The method includes processing, by the system, the intermediate output text, wherein processing the intermediate output text includes generating output text different from the input text and the intermediate output text. Generating the output text includes applying homographic attacks to the intermediate output text.

### CROSS-REFERENCE TO RELATED APPLICATIONS

This application claims the benefit of U.S. Application No. 63/637,993 filed Apr. 24, 2024, the disclosure of which is incorporated herein by reference in its entirety.

### GOVERNMENT LICENSE RIGHTS

This disclosure was made with Government support under IARPA 2022-22072200003 awarded by DOD. The Government has certain rights in the disclosure.

### BACKGROUND

The present disclosure relates to text restyling and, in particular, to systems and techniques supportive of providing text restyling for the purpose of masking the identity of the author of the text. The present disclosure relates to authorship obfuscation and, in particular, to systems and techniques for text restyling which support providing stylistically consistent authorship obfuscation.

It is sometimes desirable to make the authorship of a text unattributable and to make the transformed text stylistically consistent, so that transformed text appears to have been created by the same person, but in a writing style unlike the writing style of the original author. Use cases include masking the authorship of a whistleblower or an undercover law enforcement officer, for example, to consistently look like a different author (e.g., someone with the background of their cover).

### SUMMARY

Example embodiments of the present disclosure are directed to a method including: processing, by a system, input text, by applying a styling technique to at least a portion of the input text, wherein: applying the styling technique generates intermediate output text of a style different from a style of the input text; and the styling technique is selected based on one or more metrics associated with generating the intermediate output text; processing, by the system, the intermediate output text, wherein processing the intermediate output text includes generating output text different from the input text and the intermediate output text, wherein generating the output text includes applying homographic attacks to the intermediate output text.

In any one or combination of the embodiments disclosed herein, the method may further include: processing, by the system, the input text, by applying a second styling technique to at least the portion of the input text, wherein applying the second styling technique generates second intermediate output text of a style different from the style of the input text and the style of the intermediate output text; and selecting the styling technique, from among the styling technique and the second styling technique, based on comparing the one or more metrics associated with the intermediate output text to one or more metrics associated with the second intermediate output text.

In any one or combination of the embodiments disclosed herein, processing the intermediate output text further includes: generating second intermediate output text by: applying the styling technique to the intermediate output text; or applying a second styling technique to the intermediate output text; and processing, by the system, the second intermediate output text, wherein processing the second intermediate output text includes applying the homographic attacks to the second intermediate output text, wherein applying the homographic attacks to the second intermediate output text generates the output text.

In any one or combination of the embodiments disclosed herein, the styling technique is applied on a per-sentence basis with respect to the input text.

In any one or combination of the embodiments disclosed herein: the style of the input text is associated with a first user; and the style of the intermediate output text is associated with a second user having a target writing style different from the first user.

In any one or combination of the embodiments disclosed herein, the method may further include: selecting the styling technique based on comparing an embedding distance between the input text and the intermediate output text to a threshold embedding distance.

In any one or combination of the embodiments disclosed herein, the method may further include: selecting the styling technique based on comparing a meaning similarity between the input text and the intermediate output text to a threshold meaning similarity.

In any one or combination of the embodiments disclosed herein, the method may further include: selecting the styling technique based on comparing a language fluency associated with the intermediate output text to a threshold language fluency.

In any one or combination of the embodiments disclosed herein, the method may further include: selecting the styling technique based on comparing a perplexity difference between the input text and the intermediate output text to a threshold perplexity difference.

In any one or combination of the embodiments disclosed herein, the method may further include: calculating an objective function associated with the styling technique based on: an embedding distance between the input text and the intermediate output text; a meaning similarity between the input text and the intermediate output text; a language fluency associated with the intermediate output text; and a perplexity difference between the input text and the intermediate output text compared to a threshold perplexity difference; and selecting the styling technique based on the objective function satisfying a criterion.

In any one or combination of the embodiments disclosed herein, the method may further include: selecting the portion of the input text based on a word frequency associated with one or more words included in the portion of the input text.

In any one or combination of the embodiments disclosed herein, the method may further include: selecting the portion of the input text based on determining one or more words included in the portion of the input text are content words.

In any one or combination of the embodiments disclosed herein, the method may further include: selecting the portion of the input text based on determining one or more words included in the portion of the input text are each present in multiple documents authored by an author of the input text.

In any one or combination of the embodiments disclosed herein, applying the homographic attacks includes: applying word-level randomized transformations of one or more ASCII characters or one or more Unicode characters included in the intermediate output text to one or more respective ASCII characters or one or more respective Unicode characters, wherein the one or more respective ASCII characters are selected from a pre-generated list of candidate ASCII characters, and the one or more respective Unicode characters are selected from a pre-generated list of candidate Unicode characters.

In any one or combination of the embodiments disclosed herein, the styling technique is selected from a set of styling techniques including at least one of: a large language model styling technique; a machine translation styling technique; a style transfer technique; and an inference-time algorithm based styling technique.

Embodiments of the present disclosure are directed to a system including: a pipeline including: a set of text styling blocks, wherein each text styling block of the set of text styling blocks is configured to generate, by applying a respective styling technique to at least a portion of input text, intermediate output text of a style different from a style of the input text; a selection block configured to select a styling technique, from among the styling techniques, based on respective metrics associated with the intermediate output texts; and a homograph attack block configured to generate, by applying homographic attacks to the intermediate output text associated with the selected styling technique, output text different from the input text and the intermediate output text.

In any one or combination of the embodiments disclosed herein: a first text styling block of the set of text styling blocks is configured to generate first intermediate output text by applying a first styling technique to at least the portion of the input text; a second text styling block of the set of text styling blocks is configured to generate second intermediate output text by applying a second styling technique to at least the portion of the input text, wherein the second intermediate output text is of a style different from the style of the first intermediate output text; the selection block is configured to select the styling technique, from among the first styling technique and the second styling technique, based on comparing one or more metrics associated with the first intermediate output text to one or more metrics associated with the second intermediate output text.

In any one or combination of the embodiments disclosed herein: the system is configured to generate second intermediate output text by: applying, by a first text styling block of the set of text styling blocks, a first styling technique to the intermediate output text; or applying, by a second text styling block of the set of text styling blocks, a second styling technique to the intermediate output text; and the homograph attack block is configured to generate the output text by applying the homographic attacks to the second intermediate output text.

In any one or combination of the embodiments disclosed herein, the selection block is further configured to: calculate an objective function associated with the styling technique based on: an embedding distance between the input text and the intermediate output text generated by applying the styling technique; a meaning similarity between the input text and the intermediate output text generated by applying the styling technique; a language fluency associated with the intermediate output text generated by applying the styling technique; and a perplexity difference between the input text and the intermediate output text generated by applying the styling technique, compared to a threshold perplexity difference; and select the styling technique based on the objective function of the styling technique satisfying a criterion.

Embodiments of the present disclosure are directed to an apparatus including: a memory having computer readable instructions; one or more processors configured to execute the computer readable instructions, wherein the computer readable instructions, when executed by the one or more processors cause the apparatus to: process input text, by applying a styling technique to at least a portion of the input text, wherein: applying the styling technique generates intermediate output text of a style different from a style of the input text; and the styling technique is selected based on one or more metrics associated with generating the intermediate output text; and process the intermediate output text, wherein processing the intermediate output text includes generating output text different from the input text and the intermediate output text, wherein generating the output text includes applying homographic attacks to the intermediate output text.

Additional features and advantages are realized through the techniques of the present disclosure. Other embodiments and aspects of the disclosure are described in detail herein and are considered a part of the claimed technical concept. For a better understanding of the disclosure with the advantages and the features, refer to the description and to the drawings.

### BRIEF DESCRIPTION OF THE SEVERAL VIEWS OF THE DRAWINGS

The following descriptions should not be considered limiting in any way. With reference to the accompanying drawings, like elements are numbered alike:

FIG. 1 illustrates an example of a system that supports stylistically consistent authorship obfuscation in accordance with one or more embodiments of the present disclosure.

FIG. 2 illustrates an example of a use case in accordance with one or more embodiments of the present disclosure.

FIG. 3 illustrates an example of techniques and metrics for measuring obfuscation, and further, obfuscation system selection in accordance with one or more embodiments of the present disclosure.

FIG. 4A illustrates an example of aspects of the LLM prompt-based evaluation framework described with reference to FIG. 3.

FIG. 4B illustrates an example of aspects of linguistic acceptability on CoLA associated with the fluency modeling described with reference to FIG. 3.

FIG. 5 illustrates an example of an LLM in accordance with one or more embodiments of the present disclosure.

FIG. 6 illustrates an example of guided data generation and reinforcement learning in accordance with one or more embodiments of the present disclosure.

FIG. 7 illustrates an example of decoding in accordance with one or more embodiments of the present disclosure.

FIG. 8A illustrates an example of privacy metrics in accordance with one or more embodiments of the present disclosure.

FIG. 8B illustrates an example of text quality metrics in accordance with one or more embodiments of the present disclosure.

FIG. 9 is a block diagram of a distributed computer system, in which various aspects and functions discussed above may be practiced.

FIG. 10 illustrates an example flowchart of a method in accordance with one or more embodiments of the present disclosure.

FIG. 11 illustrates an example system in accordance with one or more embodiments of the present disclosure, in which the processing pipeline may be implemented.

FIG. 12 illustrates an example system in accordance with one or more embodiments of the present disclosure, in which a processing pipeline may be implemented.

### DETAILED DESCRIPTION

A detailed description of one or more embodiments of the disclosed apparatus and method are presented herein by way of exemplification and not limitation with reference to the Figures.

Deploying multiple authorship obfuscation techniques in one system has not generally been considered. Most authorship obfuscation use a single method and hope the obfuscation works in all cases.

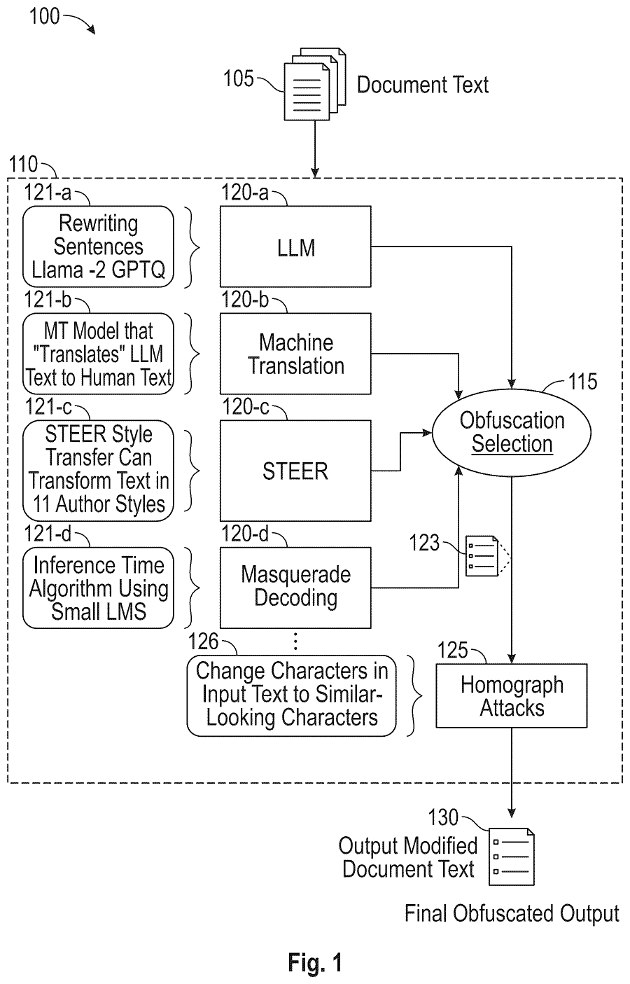

FIG. 1 illustrates an example of a system 100 that supports stylistically consistent authorship obfuscation in accordance with one or more embodiments of the present disclosure. The system 100 includes a processing pipeline 110 (also referred to herein as an obfuscation pipeline) supportive of stylistically consistent authorship obfuscation in accordance with one or more embodiments of the present disclosure.

The system 100 is capable of converting input text 105 to output text 130 using the techniques described herein. For example, the system 100 is capable of choosing a styling technique 121 (also referred to herein as an obfuscation technique, a text style transfer technique, a restyling technique, a rephrasing technique, a text transformation technique, a text conversion technique, or the like) that maximizes the difference from a given author in an embedding space such that the authorship of the input text 105 is unattributable. In some embodiments, the system 100 may choose and implement a combination of styling techniques 121 in association with converting input text 105 to output text 130. In some embodiments, the system 100 may implement a given styling technique 121 multiple times in association with converting input text 105 to output text 130. The input text 105 may be, for example, a query document described herein, but is not limited thereto.

Each styling technique 121 (obfuscation method) is capable of rephrasing text (e.g., included in the input text 105) algorithmically such that the rephrased text (e.g., included in output text 130) is stylistically distinct from the original text. Each styling technique 121 may be implemented by a respective block 120 inclusive of processing components (e.g., processing circuitry, computing devices, models, and the like) (not illustrated).

Non-limiting examples of the styling techniques 121 include a large language model (LLM) styling technique 121-a implemented at a LLM based styling block 120-a, a machine translation styling technique 121-b implemented at a machine translation based styling block 120-b, a style transfer technique 121-c (e.g., arbitrary style transfer, a unified style transfer) implemented at a style transfer based styling block 120-c, and an inference-time algorithm based styling technique 121-d (e.g., masquerade decoding) implemented at an inference-time algorithm based styling block 120-d.

The styling technique 121-a implemented at LLM based styling block 120-a may include rewriting sentences using an LLM (e.g., Llama-2 GPTQ), example aspects of which are described herein. The machine translation styling technique 121-b implemented at machine translation based styling block 120-b may include applying a machine trained (MT) model that converts (i.e., translates) LLM text to human text. The style transfer technique 121-c implemented at style transfer based styling block 120-c may include a STEER style transfer which transforms text to multiple author styles (e.g., 11 author styles), example aspects of which are described herein. The styling technique 121-d implemented at inference-time algorithm based styling block 120-d may include applying an inference time algorithm using small language models.

It is to be understood that the styling techniques 121 and associated blocks 120 provided herein are examples, and the system 100 may implement any suitable styling technique supportive of the techniques described herein in association with stylistically consistent authorship obfuscation.

The processing pipeline 110 is an overall obfuscation pipeline which may select between each styling technique 121 (and associated block 120) based on various metrics. For example, using the processing pipeline 110, the system 100 may implement a selection process (e.g., styling technique selection, obfuscation selection) at selection block 115 which determines which method is optimal based on one or more parameters. In an example, the system 100 may select and implement one or more styling techniques 121 capable of styling one or more portions of the input text 105 in association with stylistically consistent authorship obfuscation. Based on applying the styling technique(s) 121, the processing pipeline 110 may generate an intermediate output text 123 (e.g., restyled text).

As will be later described herein, the processing pipeline 110 provides features for further increasing a document embedding distance (e.g., between input text 105 and output text 130) by including orthographic attacks which are stylistically consistent, but further make the original authorship of the input text 105 unattributable. In some cases, the orthographic attacks may or may not include spelling variants. In some cases, the orthographic attacks may include adding/removing diacritical marks from letters.

For example, the processing pipeline 110 may implement homographic attacks at homograph attack block 125. In some aspects, the processing pipeline 110 may implement the homographic attacks including idiosyncratic misspellings which may mitigate or prevent effective machine recognition of the original authorship (e.g., reduce accuracy of machine recognition, increase difficulty associated with performing machine recognition).

Example styling techniques 121 (obfuscation methods) which may be provided by the blocks 120 in association with processing input text 105 and accordingly generating intermediate output text 123 and output text 130 are shown in the following Table 1.

TABLE 1

| System | Example |
|---|---|
| Original (Input | Terrorism is a global threat, but it has |
| text 105) | become more critical in Africa. |
| LLAMA2 1^{st} (LLM | Terrorism poses a worldwide risk, with its |
| based styling | severity increasingly felt across Africa. |
| block 120-a) | |
| LLAMA2 2^{nd} pass | Terrorism threatens global safety, with its |
| (LLM based styling | impact being increasingly felt throughout |
| block 120-a) | Africa and beyond. |
| STEER English | the world is now a dangerous threat, but |
| Tweet (style | it is growing more urgent in Africa |
| transfer based | |
| styling block 120-c) | |
| LLAMA2 over | The world has become an increasingly |
| STEER (LLM | threatening place, and this danger is |
| based styling block | particularly pronounced in Africa at present |
| 120-a and style | |
| transfer based | |
| styling block 120-c) | |
| Homographic | [symbol] [symbol] a worldwide risk, with its |
| attacks (homograph | severity increasingly felt across [symbol] |
| attack block 125) | |

An example Equation (1) including metrics based on which the processing pipeline 110 may select a respective block 120 in accordance with one or more embodiments of the present disclosure is provided. Equation (1) provides a combination of metrics as a single objective function.

$$Chosen system = arg {max}_{{system}_{i}} ( Avg ( Distance ( {obf}_{i} ( doc ) , doc ) \times Distance ( {obf}_{i} ( author ) , author ) \times Meaning Similarity ( {obf}_{i} ( doc ) , doc ) \times RoBERTa classifier ( {obf}_{i} ( doc ) , doc ) \times \frac{1}{GPT - 2 perplexity ( {obf}_{i} ( doc ) )} \qquad ( 1 )$$

An alternative expression of Equation (1) is provided here as Equation (1.1). Equation (1.1) provides a combination of metrics as a single objective function.

$$Chosen system = arg {max}_{{system}_{i}} ( F ( Distance ( … ) , Meaning ( … ) , Fluency ( … ) ) ) ) \qquad ( 1.1 )$$

The system 100 may select a system for each candidate author based on the various metrics indicated in Equation (1) including, for example, Document Embedding Distance, Author Embedding Distance, Meaning Similarity (Understandability), Grammaticality (Fluency), and GPT-2 Perplexity (Soundness). Aspects of the metrics are further described herein.

Document Embedding Distance: Average pairwise stylistic encoder (e.g., document level retrieval task) distances between original and obfuscated documents. In some aspects, document embedding distance is the average of all pairwise stylistic encoder (e.g., document level retrieval task) embedding distances between original and obfuscated query documents.

Author Embedding Distance: Distance between system embeddings (e.g., document level retrieval task embeddings) from query documents. In some aspects, author embedding distance is the distance between embeddings resulting after feeding all query documents into the system.

Meaning Similarity (Understandability): Average sentence-level BERT distance or Qwen or similar LLM based whole document contextual embedding distance for each document. In some aspects, meaning similarity may include document meaning similarity: average BERT distance at the whole document level. In some aspects, meaning similarity may include sentence meaning similarity: average BERT distance at the sentence level. Aspects of the present disclosure are not limited to BERT or Qwen distance, and embodiments of the present disclosure may include using any document or sentence similarity measure supportive of the techniques described herein.

Grammaticality (Fluency): Binary ROBERTa-large classifier trained on the corpus of linguistic acceptability (CoLA) dataset. Aspects of the present disclosure are not limited thereto, and embodiments of the present disclosure may include using any natural language processing (NLP) model supportive of the techniques described herein.

GPT-2 Perplexity (Soundness): Evaluates text naturalness through word sequence prediction accuracy. A perplexity score may be an indicator of whether text is likely to have been written by a human. In some aspects, GPT-2 perplexity process may include a relative perplexity difference represented by Equation (2):

$$Relative Perplexity Difference = ( Obfuscated Perplexity - Original Perplexity ) / Original Perplexity \qquad ( 2 )$$

Aspects of homographic attacks 126 which may be implemented at homograph attack block 125 are described herein.

Homograph attacks change characters in input text (e.g., intermediate output text 123) to other, similar-looking characters. Homograph attacks provide a “quick-and-dirty” way to change the appearance (without changing the meaning) of a document.

Non-limiting examples of homograph attacks provided by homograph attack block 125 are provided herein. It is to be understood that the homograph attack block 125 may implement homograph attacks different (e.g., having higher complexity) compared to the examples provided herein. For example, the homograph attack block 125 may implement homograph attacks such that the changes to the characters are less discernible to the human eye and/or computer vision based analysis techniques compared to the examples provided herein.
teamwork→team wøΓk
participants→partìcîpánts
From Cam Newton: wørd øñ thē štrēēt īš ÿøū're ñīčē īñ tēññīš.

In some cases, the modifications using some homographic attacks can be detrimental to attribution performance. Accordingly, for example, the homograph attack block 125 in accordance with one or more embodiments of the present disclosure may implement homographic attacks which include word-level randomized ASCII→Unicode transformations, ASCII→(similar) ASCII transformations, Unicode→(similar) Unicode transformations, or Unicode→ASCII transformations.

In some aspects, the homograph attack block 125 may implement homographic attacks which include misspellings (e.g., common misspellings). Non-limiting examples of common misspellings which may be incorporated by the processing pipeline 110 and implemented by the 125 include “the”→“teh”, “jewelry” (US)/“jewellery” (UK)→“jewelery”, “liaison”→“liason”, and “lightning”→“lightening”.

### Finding Candidate Words to Transform

In accordance with one or more embodiments of the present disclosure, the processing pipeline 110 may implement finding candidate words to transform from among the input text 105. Additionally, or alternatively, the processing pipeline 110 may implement finding candidate words to transform from among a transformation already implemented at a respective block 120 (e.g., LLM based styling block 120-a, machine translation based styling block 120-b, or the like). For example, the processing pipeline 110 may transform input text 105 according to a first block 120 (e.g., LLM based styling block 120-a) and generate intermediate output text 123, and the processing pipeline 110 may further transform intermediate output text 123 according to the first block 120 or a second block 120 (e.g., machine translation based styling block 120-b), prior to applying homographic attacks.

Accordingly, for example, in a case of transforming input text 105 according to the first block 120 (e.g., LLM based styling block 120-a, styling technique 121-a) to generate intermediate output text 123, and further transforming intermediate output text 123 according to the second block 120 (e.g., machine translation based styling block 120-b, machine translation styling technique 121-b), the processing pipeline 110 provides features for generating an additional styling technique 121 which partially uses word choices respectively generated by the first block 120 and the second block 120. That is, for example, the additional styling technique 121 (e.g., resulting from applying the styling technique 121-a and the machine translation styling technique 121-b) may restyle input text 105 differently compared to styling technique 121-a and machine translation styling technique 121-b individually.

Non-limiting examples of parameters (constraints) based on which the processing pipeline 110 determines (e.g., finds, selects) candidate words to transform from among the input text 105 are described herein. The processing pipeline 110 may determine or find candidate words based on any of the parameters (e.g., a single parameter, a combination of parameters, weighting factors applied to the parameters) described herein. Non-limiting examples of the parameters are described herein.

In an example parameter, the processing pipeline 110 may determine candidate words based on word frequency. For example, the processing pipeline 110 may transform not too frequent words, so that fluency is preserved. In an example, the processing pipeline 110 may select, as a candidate word, a word for which the frequency in which the word appears in the input text 105 is less than a threshold frequency. In an example, the processing pipeline 110 may select, as a candidate word, a word for which the frequency in which the word appears in the language (e.g., English language) in which the input text 105 is written is less than a threshold frequency.

Additionally, or alternatively, as an example parameter, the processing pipeline 110 may determine candidate words based on whether the words are content words. For example, from among words included in the input text 105, the processing pipeline 110 may transform a relatively small proportion of content words such that meaning is preserved. A content word (also referred to herein as a lexical word, lexical morpheme, or contentive) described herein may refer to a word that has meaning and contributes to the meaning of a sentence. In contrast to content words, for example, grammatical words are structural words and may include auxiliary verbs, pronouns, articles, and prepositions.

Additionally, or alternatively, as an example parameter, the processing pipeline 110 may determine candidate words based on whether the words appear in multiple documents authored by the same author. For example, from among words included in the input text 105 authored by a given author, the processing pipeline 110 may determine which of the words also appear in one or more other documents authored by the same author. Further, for example, the processing pipeline 110 may determine a frequency or count according to which the words also appear in one or more other documents authored by the same author. Accordingly, for example, the processing pipeline 110 may transform words that appear in multiple documents of the same author and according to a frequency greater than or equal to a threshold appearance frequency, using the same manner of transformation for those words. Accordingly, for example, the transformation may maintain stylistic consistency (e.g., such that stylistic consistency is not adversely affected).

In an example of determining candidate words to transform, the processing pipeline 110 may sort the words of a query author according to Equation (3):

$$score ( w ) = \frac{df ( w )}{tf ( w )} log ( bck . idf ( w ) ) \qquad ( 3 )$$

In Equation (3), the term bck.idf refers to an inverse document frequency based on a large background collection of texts.

### Randomizing the Transformation

In accordance with one or more embodiments of the present disclosure, the processing pipeline 110 (at homograph attack block 125) may implement randomizing the transformation. For example, for stylistic consistency, the processing pipeline 110 may implement homographic attacks which include word-level randomized ASCII→Unicode transformations that appear “unique” for an author.

An example is described for a case of an author id a and the identity of the word [symbol] to be transformed.

The processing pipeline 110 computes a “unique” hash value h=h(a, [symbol] ). From the hash value h, the processing pipeline 110 may compute seed s=h mod M in association with initializing a pseudo-random number generator. To transform an ASCII character c∈ [symbol] , the processing pipeline 110 may select a (pseudo-) random Unicode character from a pre-generated list of Unicode characters as generated by the processing pipeline 110 (e.g., the list previously generated as described herein).

In an example, the processing pipeline 110 (at homograph attack block 125) may transform the word “teamwork” as follows:

[symbol]

In replacing the “w” in “teamwork,” the processing pipeline 110 (at homograph attack block 125) may randomly select a replacement “ [symbol] ” from a pre-generated list of Unicode characters as shown in the below example:

[symbol]

Other non-limiting examples of pre-generated Unicode characters which may be selected by the processing pipeline 110 in association with a character transformations are below:

[symbol]

[symbol]

[symbol]

### Finding a Balance

In accordance with one or more embodiments of the present disclosure, the processing pipeline 110 may implement finding a balance in association with transforming the input text 105 and accordingly generating output text 130. For example, the processing pipeline 110 may implement transformations of the input text 105 (or a portion of the input text 105) using different respective blocks 120. Among the various transformations, the processing pipeline 110 may select the transformation which satisfies a target balance among factors such as, for example, obfuscation/privatization, fluency, and content preservation. In some embodiments, selecting the transformation may include selecting a styling technique 121 and quantity of iterations of applying the styling technique 121. In some embodiments, selecting the transformation may include selecting multiple styling techniques 121 and respective quantities of iterations of applying the styling techniques 121.

For example, with orthographic attacks, there is a tradeoff between obfuscation/privatization, fluency, and content preservation. As the quantity of words that are transformed increases, the more fluency and content preservation are affected (when computed automatically).

Table 2 illustrates example results associated with applying, by the processing pipeline 110, different respective transformations (i.e., styling techniques 121) to input text 105.

TABLE 2

| | | | | | Rel. | Rel. |
|---|---|---|---|---|---|---|
| | | | Author | | PPL | gramm. |
| | Obf. | EER | Emb. | Meaning | differ- | differ- |
| | method | Delta | Dist. | similarity | ence % | ence % |
| | Obf. | 0.1462 | 0.242 | 0.85 | 7 | 12.1 |
| | Sel. | | | | | |
| + orth. | 20% | 0.2122 | 0.327 | 0.763 | 9.9 | −27.4 |
| attacks | 40% | 0.2623 | 0.365 | 0.733 | −1.5 | −55.1 |
| proportion | 70% | 0.3284 | 0.396 | 0.703 | 23.3 | −59.8 |

According to one or more embodiments of the present disclosure, the processing pipeline 110 may process the input text 105, determine candidate words for transformation (i.e., restyling) as described herein, and apply a styling technique 121 on the input text 105 as a whole. Additionally, or alternatively, the processing pipeline 110 may process the input text 105, determine candidate words for transformation (i.e., restyling) as described herein, and apply a respective styling technique 121, on a per-sentence basis. Accordingly, for example, the processing pipeline 110 may provide a variable granularity based on the candidate words to be transformed (i.e., restyled), the styling technique(s) 121 to be applied, and the portions (e.g., sentences) of the input text 105 to be processed.

In accordance with one or more embodiments of the present disclosure, the processing pipeline 110 may obfuscate authorship of the input text 105 by changing stylistic attributes associated with the input text 105. In an example, the processing pipeline 110 may be include stored profiles corresponding to candidate target writing styles (e.g., a teenager, an engineer, a news reporter, a particular known individual (for example, an author, a public figure, a celebrity, or the like), a general individual of a particular demographic, and the like). The processing pipeline 110 may apply a stored profile and restyle the input text 105 (or portion(s) of the input text 105) according to a target writing style, thereby attributing resultant output text 130 to an author having the target writing style.

In some other aspects, the processing pipeline 110 may select a profile based on the amount of effective obfuscation of authorship provided by the profile (and the styling technique(s) 121 associated with the profile). For example, the processing pipeline 110 may select, from among the stored profiles, a profile for which the corresponding writing style may effectively obfuscate authorship of the input text 105. In some aspects, the system 100 may rank the effective obfuscation of authorship as provided by the various profiles (and corresponding writing styles) in accordance with parameters, equations, or tables described herein. The system 100 may select from among the profiles based on profile rank, amount of processing time associated with completing the restyling of the input text 105 according to profile, and other criteria supportive of the techniques described herein.

As described herein, the processing pipeline 110 may provide innovations in authorship obfuscation using the techniques described herein. The processing pipeline 110 provides features which satisfy an objective of text privatization for reducing the attribution performance while maintaining the original meaning and fluency of input text 105 processed and restyled by the processing pipeline 110.

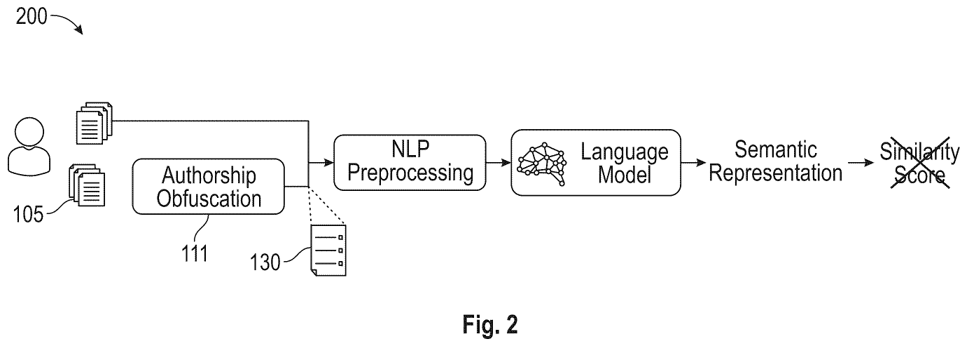

FIG. 2 illustrates an example 200 of a use case in accordance with one or more embodiments of the present disclosure. In the example 200, the processing pipeline 110 of FIG. 1 may perform operations for authorship obfuscation 111 (e.g., transforming input text 105 and generating output text 130) using the techniques described herein.

In some aspects, the processing pipeline 110 provides a technical improvement in that the output text 130 is restyled (and authorship is obfuscated) to a degree such that analysis techniques which process the output text 130 using NLP preprocessing and language models are unable to effectively generate a semantic representation and a corresponding similarity score. Accordingly, for example, without a similarity score, some analysis techniques may be unable to effectively determine authorship of the input text 105. The processing pipeline 110, through authorship obfuscation 111, is capable of effectively modifying the content of the input text 105 to protect against authorship attribution while maintaining the original meaning of the input text 105.

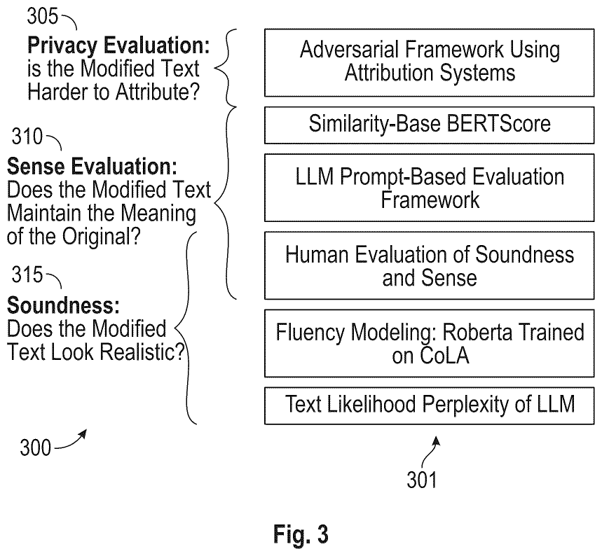

FIG. 3 illustrates an example of techniques 301 and metrics 300 for measuring obfuscation, and further, obfuscation system selection in accordance with one or more embodiments of the present disclosure. The obfuscation measurement and obfuscation system selection techniques described with reference to FIG. 3 may be implemented by processing pipeline 110 of FIG. 1, for example, at selection block 115 of FIG. 1. Some aspects of the techniques 301 and metrics 300 are previously described with reference to at least Equations (1), (1.1), and (2) described herein, and repeated descriptions of like elements are omitted for brevity.

The metrics 300 may include privacy evaluation 305, sense evaluation 310, and soundness 315.

Privacy evaluation 305 includes an evaluation of whether the modified text is harder to attribute. Privacy evaluation 305 may be implemented (at 320) using an adversarial framework using attribution systems.

Sense evaluation 310 includes an evaluation of whether the modified text (e.g., intermediate output text 123, output text 130) maintains the meaning of the original text (e.g., input text 105). Sense evaluation 310 may include (at 325) determining a similarity-base BERTScore which measures the quality of text summarization, be implemented (at 330) using an LLM prompt-based evaluation framework, and include (at 335) human evaluation of soundness and sense.

Soundness 315 includes an evaluation of whether the modified text (e.g., intermediate output text 123, output text 130) looks realistic. Soundness 315 may include (at 335) human evaluation of soundness and sense, (at 340) fluency modeling (e.g., Roberta trained on CoLA), and (at 345) text likelihood perplexity of LLM.

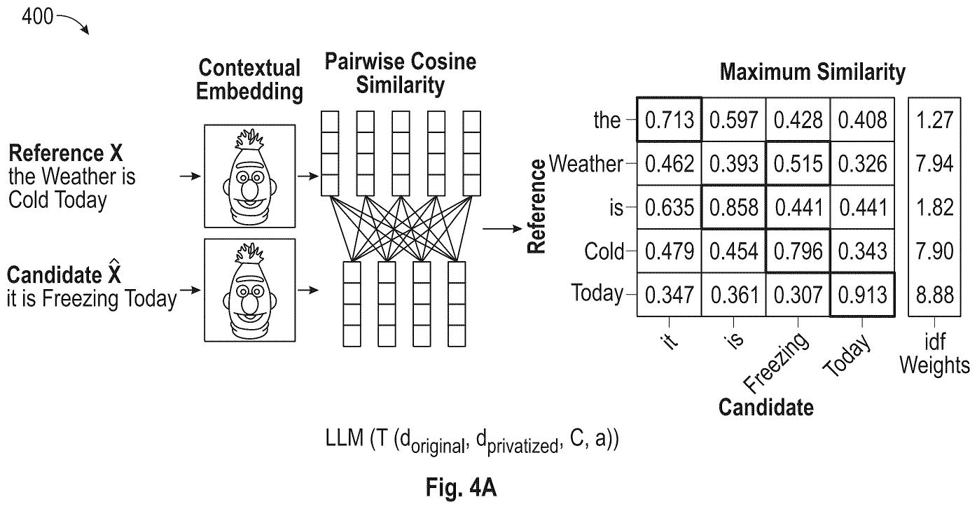

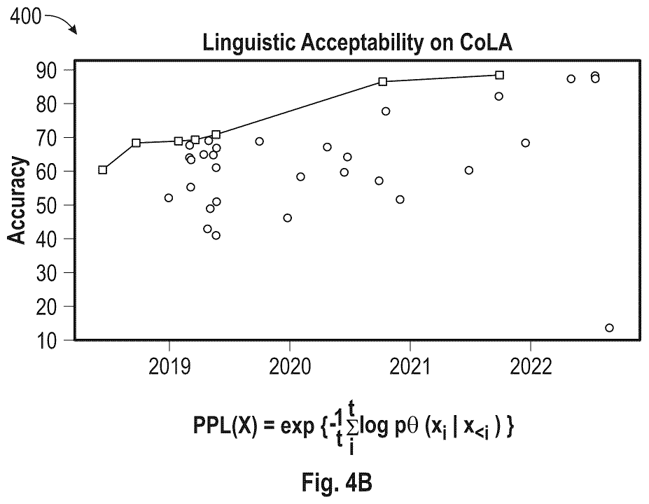

FIG. 4A illustrates an example 400 of aspects of the LLM prompt-based evaluation framework described with reference to FIG. 3.

Aspects of the LLM prompt-based evaluation framework may be expressed by Equation (3):

$$LLM ( T ( {d}_{original} , {d}_{privatized} , C , a ) ) \qquad ( 3 )$$

FIG. 4B illustrates an example 401 of aspects of linguistic acceptability on CoLA associated with the fluency modeling described with reference to FIG. 3.

Aspects of the linguistic acceptability on CoLA may be expressed by Equation (4):

$$PPL ( X ) = exp \{ - \begin{matrix}1 \\ t\end{matrix} {\sum }_{i}^{t} log {p}_{θ} ( {x}_{i} \vert {x}_{< i} ) \} \qquad ( 4 )$$

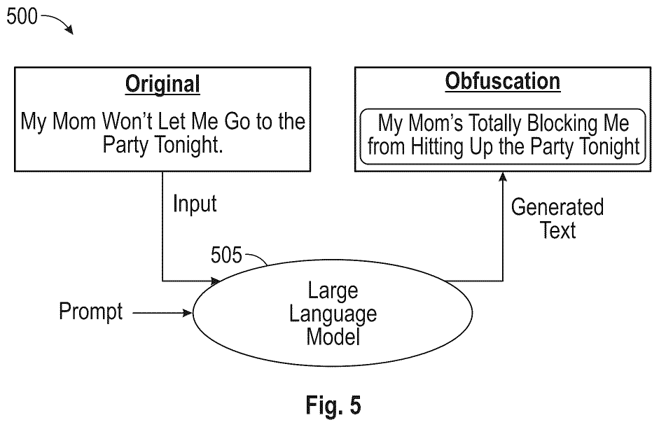

FIG. 5 illustrates an example 500 of an LLM 505 (generative AI LLM) in accordance with one or more embodiments of the present disclosure. The LLM 505 may be implemented at LLM based styling block 120-a described with reference to FIG. 1.

The LLM 505 may be configured to rephrase documents sentence-by-sentence. The LLM 505 may further incorporate GPTQ, which may save time and memory with comparable performance. In some embodiments, the LLM 505 may be Llama-2, but embodiments of the present disclosure are not limited thereto.

Table 3 illustrates an example of performance differences using Llama-2 compared to Llama-2 with GPTQ.

TABLE 3

| | |
|---|---|
| Llama-2 | Llama-2 |
| (7B chat) | w/GPTQ |

| | | | | |
|---|---|---|---|---|
| Runtime per doc | 3.41 | minutes | 34.2 | seconds |
| Model size | 38 | GB | 3.7 | GB |

Embodiments of the present disclosure support applying the LLM 505 multiple times on the same document (e.g., input text 105), rephrasing the prior outputs. Additionally, or alternatively, embodiments of the present disclosure support applying the LLM 505 multiple times on target portions of the same document, rephrasing the prior outputs.

An example conversion using Llama-2 and Llama-2 multiple times (e.g., two times) is presented below:

Original Text: The fact that the game allows individuals to work together and challenge themselves about game tactics makes it gain a high replay value.

Llama-2 Output: The game's collaborative nature and opportunity for players to test their strategies gives it a strong replay value, as individuals can work together and push one another to improve their skills.

Llama-2² Output: The cooperative aspect of the game and its potential for players to put their tactics to the test provides excellent replayability, allowing participants to team up and encourage each other to hone their abilities.

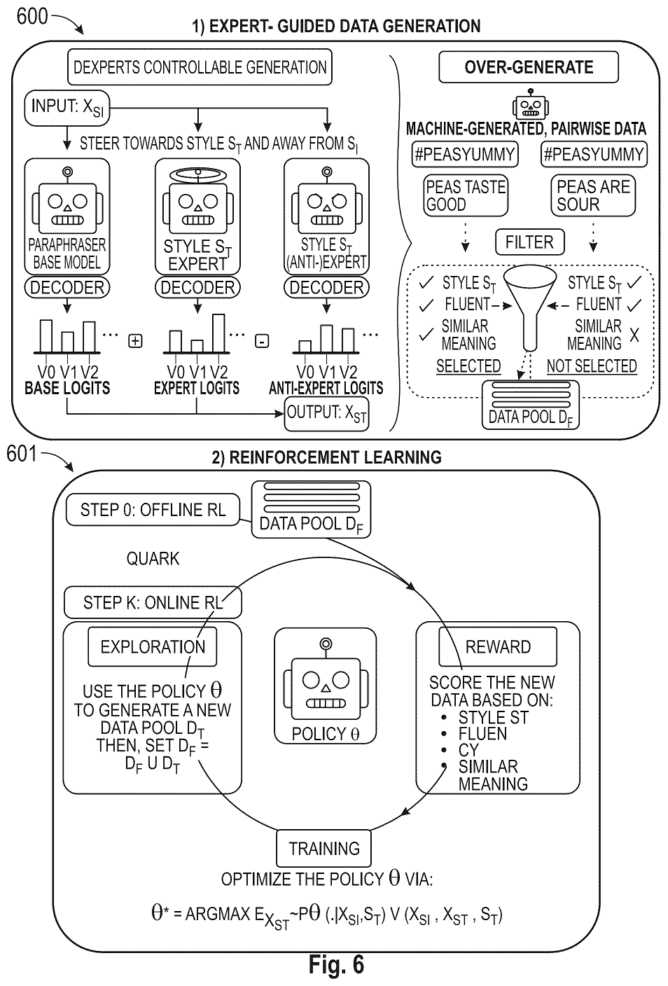

FIG. 6 illustrates an example of guided data generation 600 and reinforcement learning 601 in accordance with one or more embodiments of the present disclosure. The guided data generation 600 and reinforcement learning 601 may be implemented at style transfer based styling block 120-c described with reference to FIG. 1.

In an example, the guided data generation 600 and reinforcement learning 601 may provide arbitrary style transfer capable of rewriting text from an arbitrary, unknown style to a target style. For example, the guided data generation 600 and reinforcement learning 601 may be implemented using STEER, described in Hallinan, S., Brahman, F., Lu, X., Jung, J., Welleck, S., & Choi, Y. (2023b, November 13). STEER: Unified Style Transfer with Expert Reinforcement.

According to one or more embodiments of the present disclosure, the systems and techniques described herein may apply STEER for style transfer which transforms text (e.g., input text 105 or a portion of input text 105) to text according to one or more different author styles (e.g., 11 author styles).

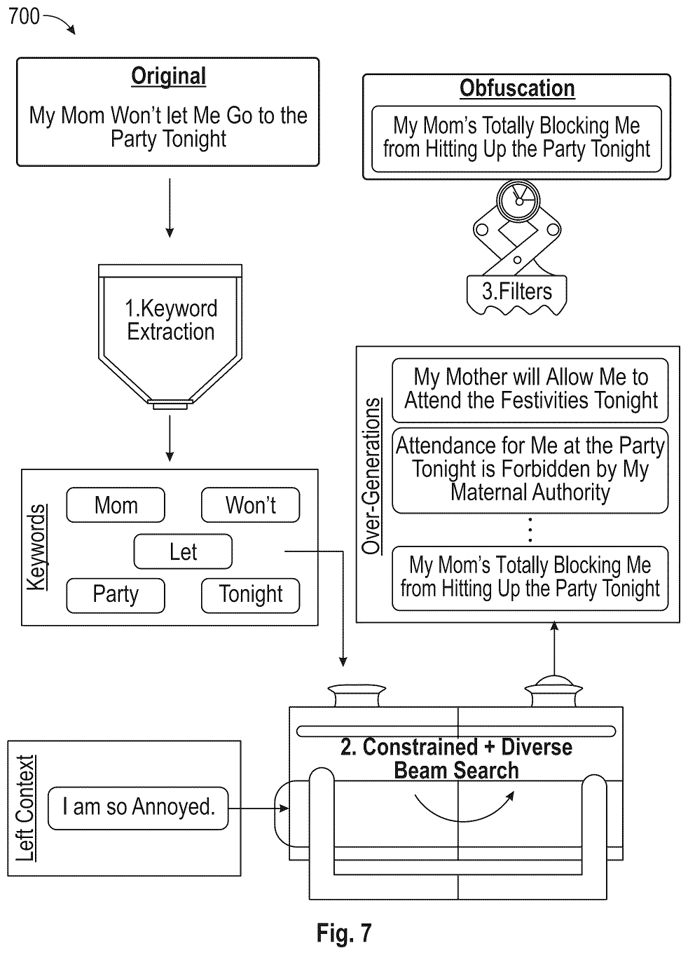

FIG. 7 illustrates an example of decoding 700 in accordance with one or more embodiments of the present disclosure. The decoding 700 may be implemented at inference-time algorithm based styling block 120-d described with reference to FIG. 1.

In an example, the decoding 700 may be provide a user-controlled, inference-time algorithm for authorship obfuscation. For example, the decoding 700 may be implemented using unsupervised authorship obfuscation using constrained decoding over small language models, such as, for example, JAMDEC, as described in Fisher, J., Lu, X., Jung, J., Jiang, L., Harchaoui, Z., & Choi, Y. (2024 February 13). JAMDEC: Unsupervised Authorship Obfuscation using Constrained Decoding over Small Language Models.

JAMDEC provides a user-controlled, inference-time algorithm for authorship obfuscation that can be applied to any text and authorship. JAMDEC uses a 3 Stage Approach as follows:

Keyword Extraction: Extract keywords to maintain original content.

Constrained+Diverse Beam Search: Augmented decoding strategy which encourages diverse but constrained generations.

Filters: Maintain fluency and content preservation, including any user-specified control.

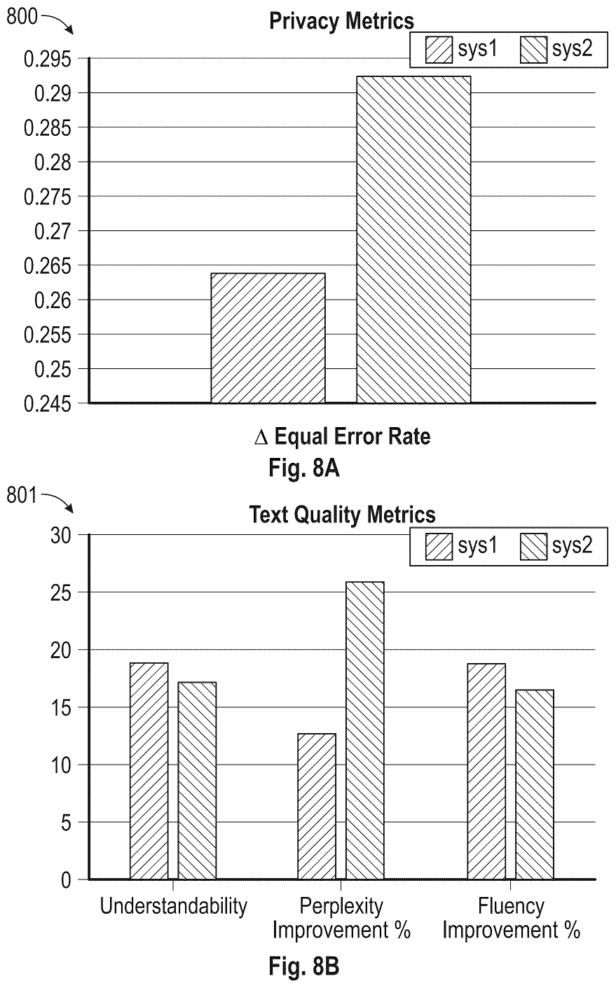

FIG. 8A illustrates an example of privacy metrics 800 in accordance with one or more embodiments of the present disclosure. FIG. 8B illustrates an example of text quality metrics 801 in accordance with one or more embodiments of the present disclosure.

The system 100 and processing pipeline 110 are capable of providing stylistically consistent authorship obfuscation and may be configured to trade off between privacy and text quality, as shown by example privacy metrics and text quality metrics 801 associated with a first system (System 1, sys1) and a second system (System 2, sys2).

With reference to FIG. 8A and FIG. 8B, System 2 exhibits a higher A Equal Error Rate, indicating diminished performance by the attribution system, which benefits privacy. System 1 maintains high text quality, characterized by better meaning similarity, enhanced fluency, and reduced perplexity.

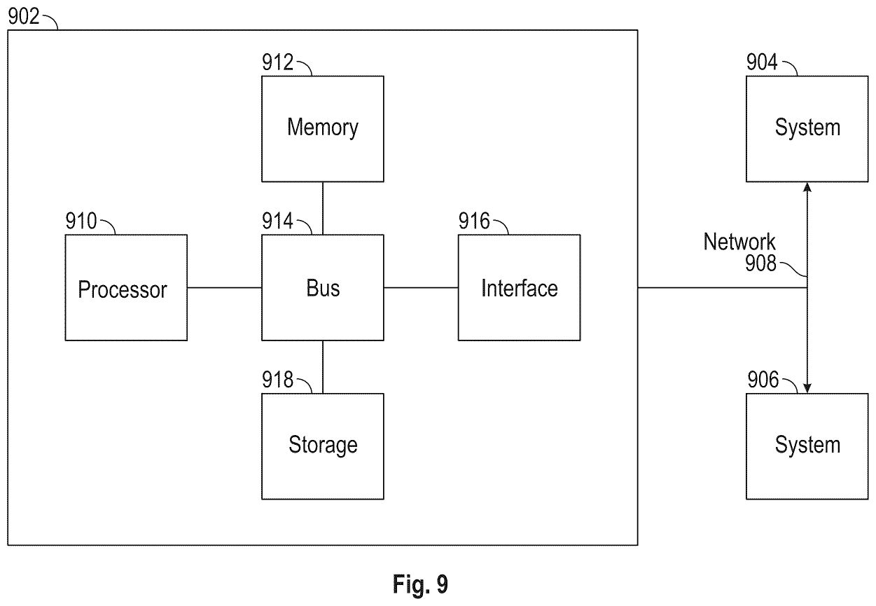

FIG. 9 is a block diagram of a distributed computer system 900, in which various aspects and functions discussed above may be practiced. The distributed computer system 900 may implement aspects of systems (e.g., system 100, processing pipeline 110) described herein.

The distributed computer system 900 may include one or more computer systems. For example, as illustrated, the distributed computer system 900 includes three computer systems 902, 904 and 906. As shown, the computer systems 902, 904 and 906 are interconnected by, and may exchange data through, a communication network 908. The network 908 may include any communication network through which computer systems may exchange data. To exchange data via the network 908, the computer systems 902, 904, and 906 and the network 908 may use various methods, protocols and standards including, among others, token ring, Ethernet, Wireless Ethernet, Bluetooth, radio signaling, infra-red signaling, TCP/IP, UDP, HTTP, FTP, SNMP, SMS, MMS, SS7, JSON, XML, REST, SOAP, CORBA IIOP, RMI, DCOM and Web Services.

According to some embodiments, the functions and operations discussed herein for stylistically consistent authorship obfuscation can be executed on computer systems 902, 904 and 906 individually and/or in combination. For example, the computer systems 902, 904, and 906 support, for example, participation in a collaborative network. In one alternative, a single computer system (e.g., 902) can provide stylistically consistent authorship obfuscation as described herein. The computer systems 902, 904 and 906 may include personal computing devices such as cellular telephones, smart phones, tablets, “fablets,” etc., and may also include desktop computers, laptop computers, etc.

Various aspects and functions in accordance with embodiments discussed herein may be implemented as specialized hardware or software executing in one or more computer systems including the computer system 902 shown in FIG. 9. In one embodiment, computer system 902 is a personal computing device specially configured to execute the processes and/or operations discussed above. As depicted, the computer system 902 includes at least one processor 910 (e.g., a single core or a multi-core processor), a memory 912, a bus 914, input/output interfaces (e.g., 916) and storage 918. The processor 910, which may include one or more microprocessors or other types of controllers, can perform a series of instructions that manipulate data. As shown, the processor 910 is connected to other system components, including a memory 912, by an interconnection element (e.g., the bus 914).

The memory 912 and/or storage 918 may be used for storing programs and data during operation of the computer system 902. For example, the memory 912 may be a relatively high performance, volatile, random access memory such as a dynamic random access memory (DRAM) or static memory (SRAM). In addition, the memory 912 may include any device for storing data, such as a disk drive or other non-volatile storage device, such as flash memory, solid state, or phase-change memory (PCM). In further embodiments, the functions and operations discussed with respect to stylistically consistent authorship obfuscation can be embodied in an application that is executed on the computer system 902 from the memory 912 and/or the storage 918. For example, the application can be made available through an “app store” for download and/or purchase. Once installed or made available for execution, computer system 902 can be specially configured to execute the functions associated with stylistically consistent authorship obfuscation.

Computer system 902 also includes one or more interfaces 916 such as input devices (e.g., camera for capturing images), output devices and combination input/output devices. The interfaces 916 may receive input, provide output, or both. The storage 918 may include a computer-readable and computer-writeable nonvolatile storage medium in which instructions are stored that define a program to be executed by the processor. The storage system 918 also may include information that is recorded, on or in, the medium, and this information may be processed by the application. A medium that can be used with various embodiments may include, for example, optical disk, magnetic disk or flash memory, SSD, among others. Further, aspects and embodiments are not to a particular memory system or storage system.

In some embodiments, the computer system 902 may include an operating system that manages at least a portion of the hardware components (e.g., input/output devices, touch screens, cameras, etc.) included in computer system 902. One or more processors or controllers, such as processor 910, may execute an operating system which may be, among others, a Windows-based operating system (e.g., Windows NT, ME, XP, Vista, 7, 8, or RT) available from the Microsoft Corporation, an operating system available from Apple Computer (e.g., MAC OS, including System X), one of many Linux-based operating system distributions (for example, the Enterprise Linux operating system available from Red Hat Inc.), a Solaris operating system available from Oracle Corporation, or a UNIX operating systems available from various sources. Many other operating systems may be used, including operating systems designed for personal computing devices (e.g., iOS, Android, etc.) and embodiments are not limited to any particular operating system.

The processor and operating system together define a computing platform on which applications (e.g., “apps” available from an “app store”) may be executed. Additionally, various functions for generating and manipulating images may be implemented in a non-programmed environment (for example, documents created in HTML, XML or other format that, when viewed in a window of a browser program, render aspects of a graphical-user interface or perform other functions). Further, various embodiments in accord with aspects of the present invention may be implemented as programmed or non-programmed components, or any combination thereof. Various embodiments may be implemented in part as MATLAB functions, scripts, and/or batch jobs. Thus, the invention is not limited to a specific programming language and any suitable programming language could also be used.

Although the computer system 902 is shown by way of example as one type of computer system upon which various functions for stylistically consistent authorship obfuscation may be practiced, aspects and embodiments are not limited to being implemented on the computer system, shown in FIG. 9. Various aspects and functions may be practiced on one or more computers or similar devices having different architectures or components than that shown in FIG. 9.

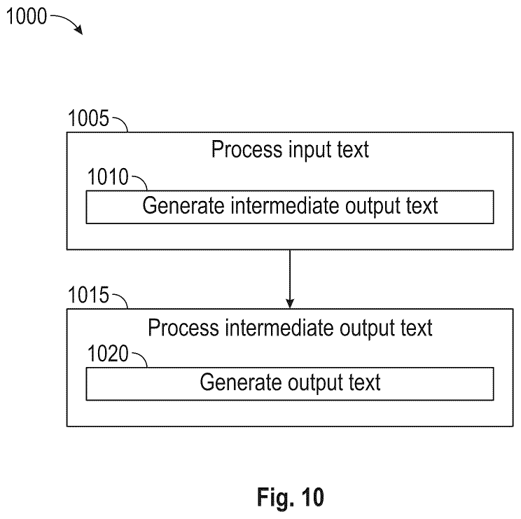

FIG. 10 illustrates an example flowchart of a method 1000 in accordance with one or more embodiments of the present disclosure. The method 1000 may be implemented by the example aspects of a system (e.g., system 100, processing pipeline 110, distributed computer system 900) described herein.

At 1005, the method 1000 includes processing, by a system, input text, by applying a styling technique to at least a portion of the input text, where: applying the styling technique generates (at 1010) intermediate output text of a style different from a style of the input text; and the styling technique is selected based on one or more metrics associated with generating the intermediate output text.

At 1015, the method 1000 includes processing, by the system, the intermediate output text, where processing the intermediate output text includes generating (at 1020) output text different from the input text and the intermediate output text, where generating the output text includes applying homographic attacks to the intermediate output text.

In some aspects, the method 1000 may include processing, by the system, the input text, by applying a second styling technique to at least the portion of the input text, where applying the second styling technique generates second intermediate output text of a style different from the style of the input text and the style of the intermediate output text. In some aspects, the method 1000 may include selecting the styling technique, from among the styling technique and the second styling technique, based on comparing the one or more metrics associated with the intermediate output text to one or more metrics associated with the second intermediate output text.

In some aspects, processing the intermediate output text further includes: generating second intermediate output text by: applying the styling technique to the intermediate output text; or applying a second styling technique to the intermediate output text. In some aspects, the method 1000 includes processing, by the system, the second intermediate output text, where processing the second intermediate output text includes applying the homographic attacks to the second intermediate output text. In some aspects, applying the homographic attacks to the second intermediate output text generates the output text.

In some aspects, the styling technique is applied on a per-sentence basis with respect to the input text.

In some aspects, the style of the input text is associated with a first user; and the style of the intermediate output text is associated with a second user having a target writing style different from the first user.

In some aspects, the method 1000 includes selecting the styling technique based on comparing an embedding distance between the input text and the intermediate output text to a threshold embedding distance.

In some aspects, the method 1000 includes selecting the styling technique based on comparing a meaning similarity between the input text and the intermediate output text to a threshold meaning similarity.

In some aspects, the method 1000 includes selecting the styling technique based on comparing a language fluency associated with the intermediate output text to a threshold language fluency.

In some aspects, the method 1000 includes selecting the styling technique based on comparing a perplexity difference between the input text and the intermediate output text to a threshold perplexity difference.

In some aspects, the method 1000 includes calculating an objective function associated with the styling technique based on: an embedding distance between the input text and the intermediate output text; a meaning similarity between the input text and the intermediate output text; a language fluency associated with the intermediate output text; and a perplexity difference between the input text and the intermediate output text compared to a threshold perplexity difference. In some aspects, the method 1000 includes selecting the styling technique based on the objective function satisfying a criterion.

In some aspects, the method 1000 includes selecting the portion of the input text based on a word frequency associated with one or more words included in the portion of the input text.

In some aspects, the method 1000 includes selecting the portion of the input text based on determining one or more words included in the portion of the input text are content words.

In some aspects, the method 1000 includes selecting the portion of the input text based on determining one or more words included in the portion of the input text are each present in multiple documents authored by an author of the input text.

In some aspects, applying the homographic attacks includes: applying word-level randomized transformations of one or more ASCII characters or one or more Unicode characters comprised in the intermediate output text to one or more respective ASCII characters or one or more respective Unicode characters, wherein: the one or more respective ASCII characters are selected from a pre-generated list of candidate ASCII characters, and the one or more respective Unicode characters are selected from a pre-generated list of candidate Unicode characters.

For example, applying the homographic attacks may include: applying word-level randomized transformations of one or more ASCII characters included in the intermediate output text to one or more respective Unicode characters or one or more respective second ASCII characters, wherein the one or more respective Unicode characters are selected from a pre-generated list of candidate Unicode characters and the one or more respective second ASCII characters are selected from a pre-generated list of candidate ASCII characters. In some aspects, the one or more respective second ASCII characters may be visually similar or visually indistinguishable from the one or more ASCII characters.

In another example, applying the homographic attacks may include: applying word-level randomized transformations of one or more Unicode characters included in the intermediate output text to one or more respective second Unicode characters or one or more respective ASCII characters, wherein the one or more respective second Unicode characters are selected from the pre-generated list of candidate Unicode characters, and the one or more respective ASCII characters are selected from a pre-generated list of candidate ASCII characters. In some aspects, the one or more respective second Unicode characters may be visually similar or visually indistinguishable from the one or more Unicode characters.

In some aspects, the styling technique is selected from a set of styling techniques including at least one of: a large language model styling technique; a machine translation styling technique; a style transfer technique; and an inference time algorithm based styling technique.

Aspects of the systems and techniques described herein may be implemented for use cases which may benefit from authorship obfuscation.

As described herein, systems and techniques for attribution and obfuscation are provided which robustly secure user privacy in digital communications.

The systems and techniques described herein may provide stylistically consistent authorship obfuscation which may mitigate or prevent authorship attribution, and particularly, protect against authorship attribution techniques which are based on AI and NLP.

In general, authorship attribution may include inferring the authorship of text based on its linguistic characteristics. In general, authorship attribution may include identifying the correct author of a document given a range of possible authors. In some cases, authorship attribution may be used for historical analysis (e.g., determining the author of a disputed or anonymous text), plagiarism detection (e.g., detecting text re-use from other authors), forensic investigation (e.g., investigating crimes such as extortion, threats, identity theft, and the like), disinformation/influence campaigns (e.g., detecting the use of fake identities to manipulate public opinion), and human trafficking (e.g., identifying authorship of online human trafficking advertisements).

The stylistically consistent authorship obfuscation provided by the systems and techniques described herein may effectively protect against authorship attribution techniques such as, for example, AI models which analyze complex stylistic nuances beyond traditional metrics (e.g., from word counts to deep patterns), LLMs capable of learning subtle semantic patterns indicative of authorship, massively parallel processing (e.g., scaled up with GPUs) which enables the analysis of vast datasets and complex models, and AI techniques configured for transforming subtle writing patterns into distinct, traceable signatures.

The stylistically consistent authorship obfuscation provided by the systems and techniques described herein may protect against: deep learning models configured to unmask disguised writing style, AI assisted analysis of communications, plagiarism detectors which use deep learning to compare stylistic elements and detect paraphrasing or disguised copying, AI and authorship analysis employed at scale for detecting networks of accounts controlled by a single entity, deep learning employed for identifying stylistic markers in an author's online posts.

The stylistically consistent authorship obfuscation provided by the systems and techniques described herein provide a practical application for protecting author anonymity in an online environment. For example, in an online environment, casual social media activity may leave a stylistic fingerprint. As to data Aggregation, some approaches combine authorship analysis with other data (e.g., location, browsing history) for building a complete profile of a user. As to individuals who may be considered to be whistleblowers and dissenters by authoritarian regimes or powerful corporations, the stylistically consistent authorship obfuscation provided by the systems and techniques described herein may prevent such entities from suppressing criticism, as the systems and techniques described herein may prevent the entities from identifying the authors of critical content. Further, for example, the stylistically consistent authorship obfuscation provided by the systems and techniques described herein may prevent the misuse of authorship attribution: authorship attribution on a large scale could lead to online harassment and reputational harm based on misinterpreted or out-of-context writing.

The systems and techniques described herein provide technical improvements in authorship obfuscation and text anonymization. For example, with reference back to FIG. 2, the processing pipeline 110 of FIG. 1 may perform operations for authorship obfuscation 111, which may modify the content of a text sample and protect against authorship attribution while maintaining the original meaning of the text. The stylistically consistent authorship obfuscation provided by the systems and techniques described herein support safeguarding individuals, such as, for example, human rights activists, journalists, and dissidents, whose anonymity is crucial for their safety.

The systems and techniques described herein provide technical improvements through the metric-based selection of techniques for authorship obfuscation, as opposed to approaches which focus on applying a single obfuscation technique and attempting to improve performance (e.g., accuracy, speed) of the individual obfuscation technique.

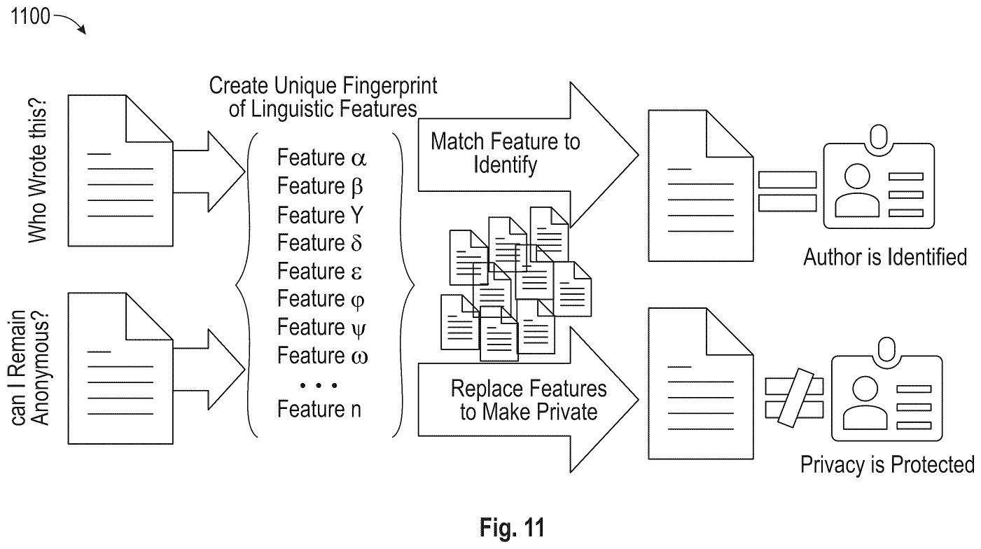

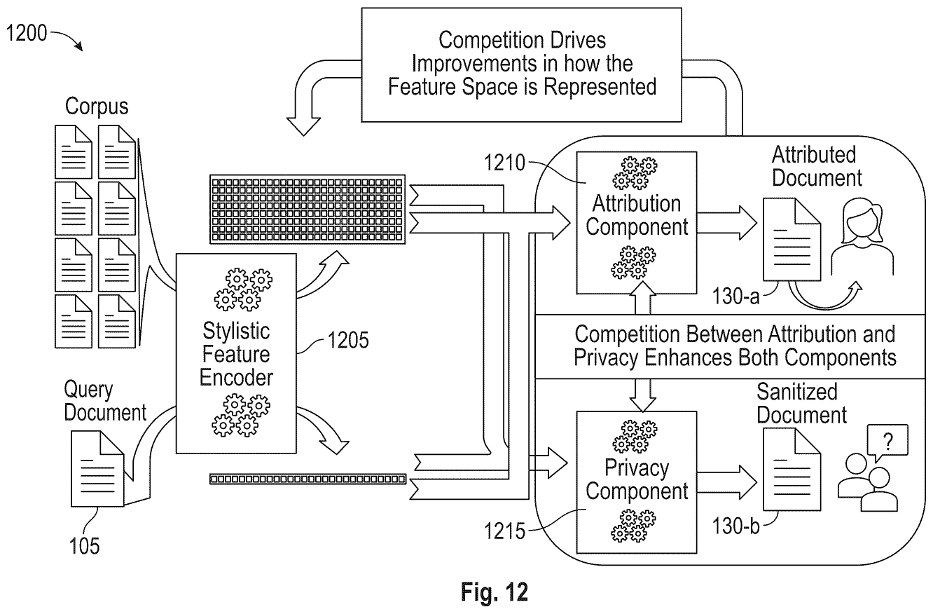

FIG. 11 illustrates an example system 1100 in accordance with one or more embodiments of the present disclosure, in which the processing pipeline 110 may be implemented. FIG. 12 illustrates an example system 1200 (adversarial framework) in accordance with one or more embodiments of the present disclosure, in which the processing pipeline 110 may be implemented.

With reference to FIGS. 11 and 12, the system 100 and processing pipeline 110 described herein may be implemented in association with bridging attribution and privacy. For example, the processing pipeline 110 may apply a combination of styling techniques 121 and/or homographic attacks 126 as desired for protecting against authorship attribution and for preserving privacy.

With reference to FIG. 12, aspects of the processing pipeline 110 may be implemented at a stylistic feature encoder 1205, an attribution component 1210, and a privacy component 1215. To drive improvement in all three components, adversarial evaluation of the attribution and privacy system is employed.

For example, the processing pipeline 110 may be implemented at the stylistic feature encoder 1205 and/or the attribution component 1210 such that a resultant output text 130 may be attributed to an author having a target writing style, rather than the actual author of the input text 105. In another example, the processing pipeline 110 may be implemented at the stylistic feature encoder 1205 and/or the privacy component 1215 such that a resultant output text 130 is a sanitized document, for which the authorship has been obfuscated or is incapable of being determined.

In the descriptions of the flowcharts herein, the operations may be performed in a different order than the order shown, or the operations may be performed in different orders or at different times. Certain operations may also be left out of the flowcharts, one or more operations may be repeated, or other operations may be added to the flowcharts.

The term “about” is intended to include the degree of error associated with measurement of the particular quantity based upon the equipment available at the time of filing the application.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

The corresponding structures, materials, acts and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the technical concepts in the form disclosed. Many modifications and variations will be apparent to those of ordinary skill in the art without departing from the scope and spirit of the disclosure. The embodiments were chosen and described in order to best explain the principles of the disclosure and the practical application and to enable others of ordinary skill in the art to understand the disclosure for various embodiments with various modifications as are suited to the particular use contemplated.

While the present disclosure has been described with reference to an example embodiment or embodiments, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the claims.

What is claimed is:

1. A method comprising:
processing, by a system, input text, by applying a styling technique to at least a portion of the input text, wherein:
applying the styling technique generates intermediate output text of a style different from a style of the input text; and
the styling technique is selected based on one or more metrics associated with generating the intermediate output text; and
processing, by the system, the intermediate output text, wherein processing the intermediate output text comprises generating output text different from the input text and the intermediate output text, wherein generating the output text comprises applying homographic attacks to the intermediate output text.

2. The method of claim 1, further comprising:
processing, by the system, the input text, by applying a second styling technique to at least the portion of the input text, wherein applying the second styling technique generates second intermediate output text of a style different from the style of the input text and the style of the intermediate output text; and
selecting the styling technique, from among the styling technique and the second styling technique, based on comparing the one or more metrics associated with the intermediate output text to one or more metrics associated with the second intermediate output text.

3. The method of claim 1, wherein processing the intermediate output text further comprises:
generating second intermediate output text by:
applying the styling technique to the intermediate output text; or
applying a second styling technique to the intermediate output text; and
processing, by the system, the second intermediate output text, wherein processing the second intermediate output text comprises applying the homographic attacks to the second intermediate output text,
wherein applying the homographic attacks to the second intermediate output text generates the output text.

4. The method of claim 1, wherein the styling technique is applied on a per-sentence basis with respect to the input text.

5. The method of claim 1, wherein:
the style of the input text is associated with a first user; and
the style of the intermediate output text is associated with a second user having a target writing style different from the first user.

6. The method of claim 1, further comprising:
selecting the styling technique based on comparing an embedding distance between the input text and the intermediate output text to a threshold embedding distance.

7. The method of claim 1, further comprising:
selecting the styling technique based on comparing a meaning similarity between the input text and the intermediate output text to a threshold meaning similarity.

8. The method of claim 1, further comprising:
selecting the styling technique based on comparing a language fluency associated with the intermediate output text to a threshold language fluency.

9. The method of claim 1, further comprising:
selecting the styling technique based on comparing a perplexity difference between the input text and the intermediate output text to a threshold perplexity difference.

10. The method of claim 1, further comprising:
calculating an objective function associated with the styling technique based on:
an embedding distance between the input text and the intermediate output text;
a meaning similarity between the input text and the intermediate output text;
a language fluency associated with the intermediate output text; and
a perplexity difference between the input text and the intermediate output text compared to a threshold perplexity difference; and
selecting the styling technique based on the objective function satisfying a criterion.

11. The method of claim 1, further comprising:
selecting the portion of the input text based on a word frequency associated with one or more words comprised in the portion of the input text.

12. The method of claim 1, further comprising:
selecting the portion of the input text based on determining one or more words comprised in the portion of the input text are content words.

13. The method of claim 1, further comprising:
selecting the portion of the input text based on determining one or more words comprised in the portion of the input text are each present in multiple documents authored by an author of the input text.

14. The method of claim 1, wherein applying the homographic attacks comprises applying word-level randomized transformations of one or more ASCII characters or one or more Unicode characters comprised in the intermediate output text to one or more respective ASCII characters or one or more respective Unicode characters, wherein:
the one or more respective ASCII characters are selected from a pre-generated list of candidate ASCII characters, and
the one or more respective Unicode characters are selected from a pre-generated list of candidate Unicode characters.

15. The method of claim 1, wherein the styling technique is selected from a set of styling techniques comprising at least one of:
a large language model styling technique;
a machine translation styling technique;
a style transfer technique; and
an inference-time algorithm based styling technique.

16. A system comprising:
a pipeline comprising:
a set of text styling blocks, wherein each text styling block of the set of text styling blocks is configured to generate, by applying a respective styling technique to at least a portion of input text, intermediate output text of a style different from a style of the input text;
a selection block configured to select a styling technique, from among the styling techniques, based on respective metrics associated with the intermediate output texts; and
a homograph attack block configured to generate, by applying homographic attacks to the intermediate output text associated with the selected styling technique, output text different from the input text and the intermediate output text.

17. The system of claim 16, wherein:
a first text styling block of the set of text styling blocks is configured to generate first intermediate output text by applying a first styling technique to at least the portion of the input text;
a second text styling block of the set of text styling blocks is configured to generate second intermediate output text by applying a second styling technique to at least the portion of the input text, wherein the second intermediate output text is of a style different from the style of the first intermediate output text; and
the selection block is configured to select the styling technique, from among the first styling technique and the second styling technique, based on comparing one or more metrics associated with the first intermediate output text to one or more metrics associated with the second intermediate output text.

18. The system of claim 16, wherein:
the system is configured to generate second intermediate output text by:
applying, by a first text styling block of the set of text styling blocks, a first styling technique to the intermediate output text; or
applying, by a second text styling block of the set of text styling blocks, a second styling technique to the intermediate output text; and
the homograph attack block is configured to generate the output text by applying the homographic attacks to the second intermediate output text.

19. The system of claim 16, wherein the selection block is further configured to:
calculate an objective function associated with the styling technique based on:
an embedding distance between the input text and the intermediate output text generated by applying the styling technique;
a meaning similarity between the input text and the intermediate output text generated by applying the styling technique;
a language fluency associated with the intermediate output text generated by applying the styling technique; and
a perplexity difference between the input text and the intermediate output text generated by applying the styling technique, compared to a threshold perplexity difference; and
select the styling technique based on the objective function of the styling technique satisfying a criterion.

20. An apparatus comprising:
a memory having computer readable instructions;
one or more processors configured to execute the computer readable instructions, wherein the computer readable instructions, when executed by the one or more processors cause the apparatus to:
process input text, by applying a styling technique to at least a portion of the input text, wherein:
applying the styling technique generates intermediate output text of a style different from a style of the input text; and
the styling technique is selected based on one or more metrics associated with generating the intermediate output text; and
process the intermediate output text, wherein processing the intermediate output text comprises generating output text different from the input text and the intermediate output text, wherein generating the output text comprises applying homographic attacks to the intermediate output text.
